(19) United States
(12) Patent Application Publication
(10) Pub. No.: US 2015/0088700 A1
(43) Pub. Date: Mar. 26, 2015

(54) RECOMMENDATIONS FOR SELLING PAST PURCHASES

(71) Applicants: Scot Fraser Hamilton, Dublin, CA (US); Steve Cheng, Palo Alto, CA (US); Lien Ekdahl, Alviso, CA (US); Amanda Thomas, San Francisco, CA (US)

(72) Inventors: Scot Fraser Hamilton, Dublin, CA (US); Steve Cheng, Palo Alto, CA (US); Lien Ekdahl, Alviso, CA (US); Amanda Thomas, San Francisco, CA (US)

(73) Assignee: eBay Inc., San Jose, CA (US)

(21) Appl. No.: 14/033,265

(22) Filed: Sep. 20, 2013

(51) Int. Cl. G06Q 10/08

(52) U.S. Cl. CPC G06Q 10/087
USPC 705/28

(57) ABSTRACT

A system and method of generating recommendations for users to sell items that they have previously purchased are described. An inventory of items of a user may be determined. The inventory of items may comprise items the user has purchased. For each item in the inventory of items, corresponding sale price information and corresponding purchase date information reflecting when the user purchased the corresponding item may be determined. A score may then be determined for each item in the inventory of items based on the corresponding sale price information and the corresponding purchase date information. At least one item from the inventory of items may be determined to recommend for sale by the user based on the corresponding score of the at least one item.

### TECHNICAL FIELD

The present application relates generally to the technical field of data processing, and, in various embodiments, to systems and methods of generating recommendations for users to sell items that they have previously purchased.

### BACKGROUND

The Internet has made it easier for people to buy and sell items. However, deciding which previously-purchased items to sell, as well appropriate sale prices, can be difficult.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating components of a recommendation system, in accordance with some embodiments;

FIG. 5 is a flowchart illustrating a method of generating a recommendation of items to sell, in accordance with some embodiments;

FIG. 6 is a flowchart illustrating a method of selecting items to recommend for sale, in accordance with some embodiments;

FIG. 7 illustrates a recommendation to sell items, in accordance with some embodiments; and

FIG. 8 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of generating recommendations for users to sell items that they have previously purchased. A user's past purchase history may be used to determine what items the user currently has in his or her inventory. Information regarding when the user purchased an item, as well as information regarding the selling price of the same or similar items (e.g., items having the same product identification), may be used to determine a score for the item. The score may also be influenced by certain context factors, including, but not limited to, the amount of buying activity and/or selling activity the user has engaged in with respect to items having the same or similar category as the item for which the score is being determined, supply and demand information regarding the item, and event information related to the item (e.g., a promotional event for a new version of the item). Items from the user's inventory may be selected to be recommended for sale. These recommendations may then be provided to the user.

In some embodiments, an inventory of items of a user may be determined. The inventory of items may comprise items the user has purchased. For each item in the inventory of items, corresponding sale price information and corresponding purchase date information reflecting when the user purchased the corresponding item may be determined. A score may then be determined for each item in the inventory of items based on the corresponding sale price information and the corresponding purchase date information. At least one item from the inventory of items may be determined to recommend for sale by the user based on the corresponding score of the at least one item.

In some embodiments, the sale price information may comprise an average selling price (ASP) for a plurality of items each having the same product identification as the corresponding item. In some embodiments, for each item in the inventory of items, the step of determining a score may be conditioned upon the corresponding average selling price satisfying a minimum threshold. In some embodiments, for each item in the inventory of items, the step of determining a score may be conditioned upon the corresponding purchase date information reflecting that a minimum threshold amount of time has passed since the corresponding item was purchased by the user. In some embodiments, the corresponding scores of the items may be weighted based on measurements of the user's buying activity and selling activity in item categories associated with the items. In some embodiments, the item(s) to recommend for sale may be determined by ranking the item in the inventory of items based on their corresponding scores, and selecting either a top portion or a bottom portion of the ranked items as the item(s) to recommend for sale. In some embodiments, a recommendation to sell the determined item(s) may be provided to the user. In some embodiments, the recommendation may comprise the sale price information corresponding to the determined item(s). In some embodiments, the inventory of items may be determined by accessing the user's buying and selling history on at least one e-commerce website.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

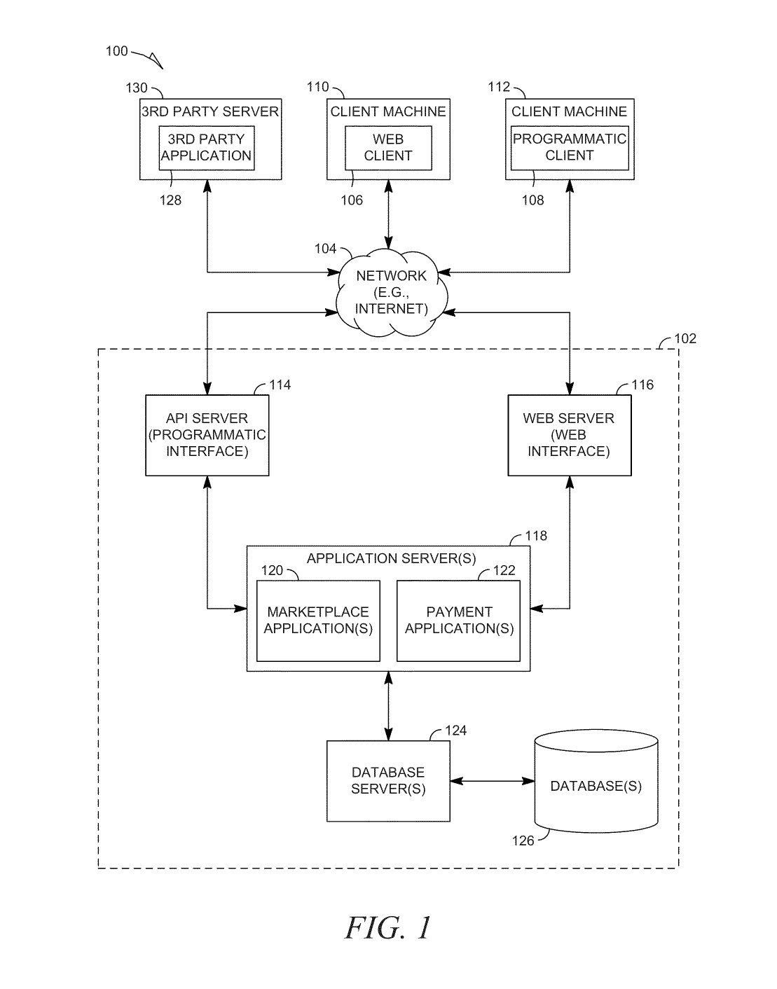

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

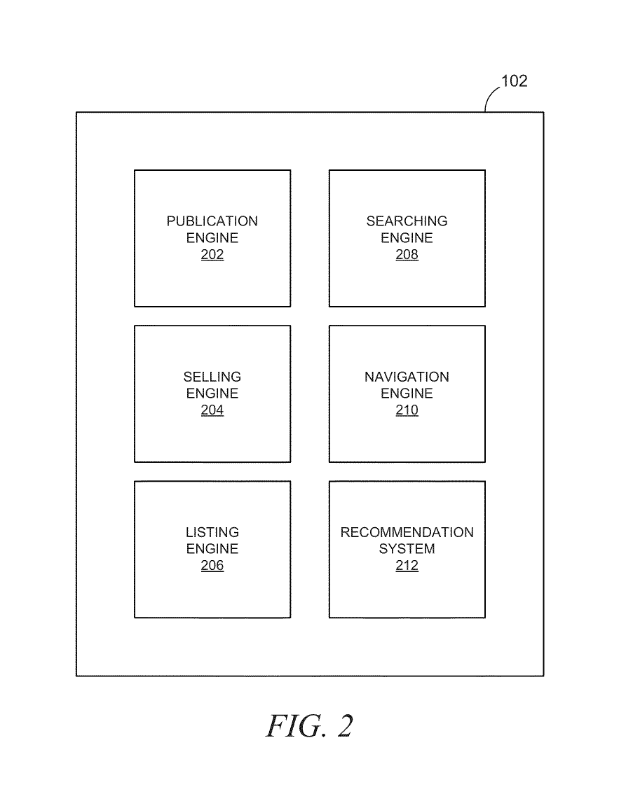

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 may also allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

In some embodiments, a recommendation system 212 may be configured to generate and provide recommendations to sell one or more items in a user's inventory of items. The features, functions, and operations of the recommendation system 212 will be discussed in further below.

Additional modules and engines associated with the networked system 102 are described below in further detail. It should be appreciated that modules or engines may embody various aspects of the details described below.

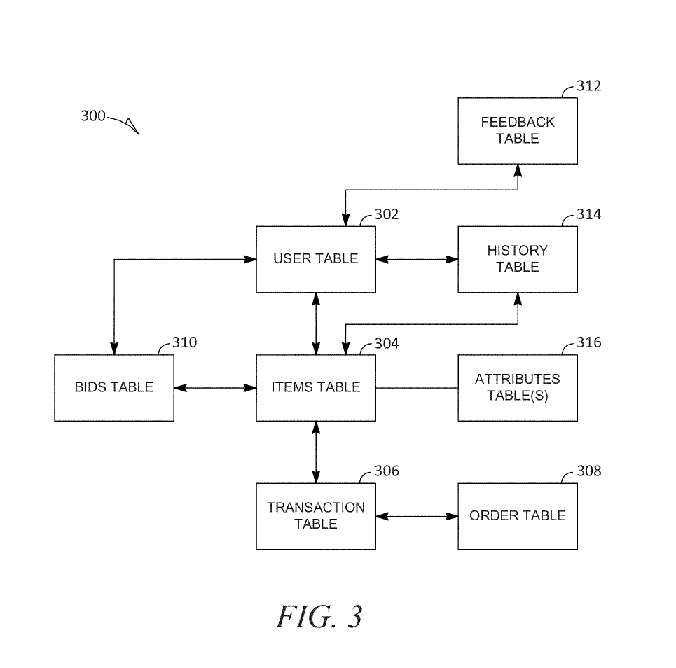

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, with the currency attribute identifying the currency of a price for the relevant item as specified by a seller.

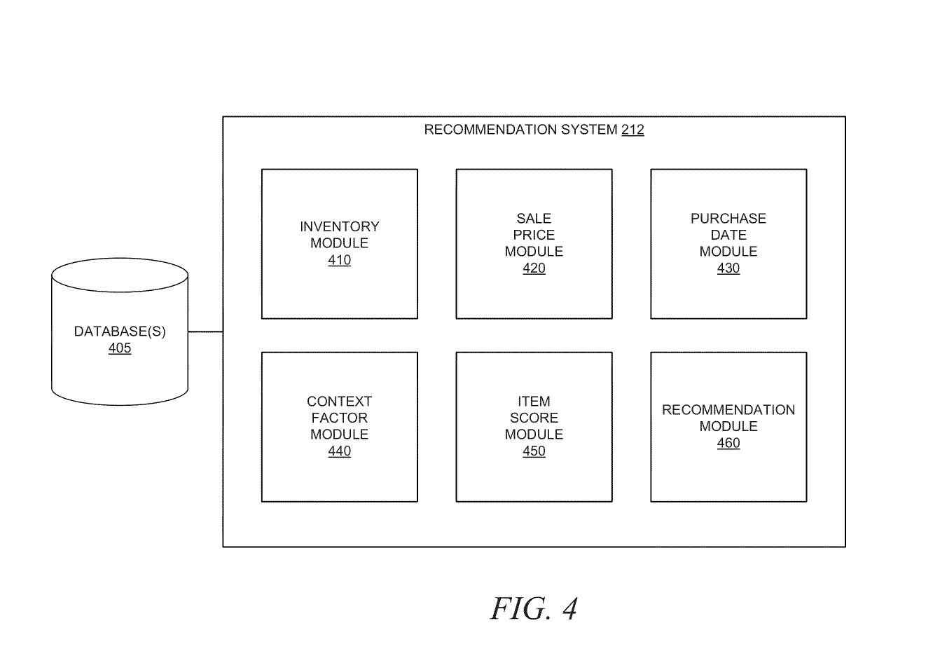

FIG. 4 is a block diagram illustrating components of recommendation system 212, in accordance with some embodiments. In some embodiments, some or all of the modules and components of the recommendation system 212 may be incorporated into or implemented using the components of publication system 102 in FIG. 1. For example, the modules of the recommendation system 212 may be incorporated into the application servers 118. In addition, the modules and components of the recommendation system 212 may have separate utility and application outside of the publication system 102 of FIG. 1. Recommendation system 212 may comprise an inventory module 410, a sale price module 420, a purchase date module 430, a context factor module 440, an item score module 450, and a recommendation module 460. It is contemplated that other configurations are also within the scope of the present disclosure.

Inventory module 410 may be configured to determine an inventory of items of a user. In some embodiments, the inventory of items comprises a list of items that the user has purchased, but not yet sold (or otherwise given to someone else). This list of items may be determined in a variety of ways and from a variety of sources. In some embodiments, the inventory module 410 may access and retrieve information about the user's buying activity and selling activity on e-commerce websites with which the recommendation system 212 is affiliated. For example, in a scenario where the recommendation system 212 belongs to or is being used by a single e-commerce company to generate recommendations of items for the user to sell, the inventory module 410 may collect information about the user's buying activity and selling activity from any websites belonging to or being controlled by that single e-commerce company. In some embodiments, the inventory module 410 may extend its collection of information about the user's buying activity and selling activity to external companies that are separate from and independent of the e-commerce company to which it belongs or by which it is being controlled. This information may be retrieved from the user's e-mail account (where receipts or records of the user's transactions may be found) or from the records of these external entities themselves.

The information about the user's buying activity and selling activity may be stored on and retrieved from one or more databases 405. In some embodiments, database(s) 405 may be incorporated into database(s) 126 in FIG. 1. However, it is contemplated that other configurations are also within the scope of the present disclosure. As previously mentioned, the information about the user's buying activity and selling activity can be used to determine the inventory of items for the user. For example, if the user's buying and selling history reflects that the user purchased Item 1 and Item 2, and sold only Item 1, then the inventory module 410 may infer that the user still has Item 2. Therefore, it may be determined that the user's inventory comprises Item 2. It is contemplated that the user's inventory of items may be determined in other ways as well.

Sale price module 420 may be configured to determine corresponding sale price information for each item in the inventory of items. In some embodiments, this sale price information may comprise an average sale price of the same or substantially similar product as the corresponding item. In some embodiments, a sample of selling prices for items having the same product identification as the item for which the average sale price is being determined may be used to determine the average sale price. For example, in determining the average sale price for a certain camera, the sale price module 420 may use a seven-day window sampling of selling prices for cameras having the same product identification (e.g., same brand and model), and the average sale price of these cameras may be determined, thereby determining the average sale price for the camera. Attributes including, but not limited to, color, size, and condition, may also be used to filter the sampling of selling prices for items that are sufficiently similar. The selling prices may comprise the actual prices at which the items were sold and/or the prices at which the items were offered for sale. Additionally, it is contemplated that other types of sale price information may be used, including, but not limited to, the highest sale price, the lowest sale price, and the median sale price.

Purchase date module 430 may be configured to determine corresponding purchase date information for each item in the inventory of items. The purchase date information may reflect when the user purchased the corresponding item. For example, the purchase date information may comprise the specific date on which the user purchased the corresponding item. However, it is contemplated that other types of purchase date information are also within the scope of the present disclosure. For example, the purchase date information may simply comprise the amount of time (e.g., 60 days) since the user purchased the corresponding item, rather than the specific date on which the item was purchased. The purchase date information may be stored on and retrieved from database(s) 405. In some embodiments, the purchase date information of an item may be an approximation of the age of that item, independent of when a purchase was actually made. For example, an item may have been first brought onto the market two years ago, but not actually purchased until six months ago. The purchase date information may comprise the two year age of the item and/or the six month date of purchase of the item. In some embodiments, the purchase date information may be retrieved from the same sources from where the information about the user's buying activity is retrieved.

Item score module 450 may be configured to determine a score for each item in the inventory of items based on the corresponding sale price information and the corresponding purchase date information of each corresponding item. The item score module 450 may determine the score for an item using one or more equations that incorporate the sale price information and/or the purchase date information. In some embodiments, the sale price information of an item has a direct relationship with the score for the item (e.g., the higher the average sale price of the item, the higher the score for the item will be). In some embodiments, the amount of time that has passed since the item was purchased by the user or the age of an item has a direct relationship with the score for the item (e.g., the longer it has been since the user purchased the item or the older an item is, the higher the score for the item will be). In some embodiments, the older an item is, the more likely the item may be to be recommended for sale (e.g., the higher the score for the item will be). This preference for older items may be applied to certain types or categories of items, such as collectibles and antiques, for which older age is considered to add value.

In some embodiments, items in the user's inventory of items may be filtered out from the scoring process or otherwise eliminated from consideration for being recommended to be sold based on one or more conditions not being met. For example, in some embodiments, the corresponding sale price information for an item must satisfy a minimum threshold (e.g., the average sale price must be at least $10.00) in order for a score to be determined for the item or in order for the item to otherwise be considered for being recommended to be sold. In some embodiments, the corresponding purchase date information for an item must reflect that a minimum threshold amount of time (e.g., 6 months) has passed since the corresponding item was purchased by the user in order for a score to be determined for the item or in order for the item to otherwise be considered for being recommended to be sold.

In some embodiments, the corresponding scores of the items may be weighted based on, or otherwise influenced by, context factors regarding the user or the corresponding item. The information upon which the context factors are based may be obtained from internal and/or external sources.

One context factor may be a measurement of the user's buying activity and selling activity in the item category corresponding to item. In some embodiments, the more a user has engaged in buying activity and/or selling activity within a particular category, the more positively affected the score will be of any item belonging to that particular category, thereby increasing the likelihood that items within that particular category will be recommended for sale. The idea is that the more the user has engaged in buying activity and/or selling activity with respect to items within a certain category, the more likely that the user will be interested in selling an item that belongs to that same category. In some embodiments, the buying activity comprises only completed purchases. In some embodiments, the buying activity may also comprise attempted purchases (e.g., bids on items). In some embodiments, the selling activity comprises only completed sales. In some embodiments, the selling activity may also comprise attempted sales (e.g., offers for sale). In some embodiments, the eligibility of the buying activity and the selling activity to be used as a context factor may be subject to the corresponding activity having occurred within a predetermined amount of time from the time the score is being determined (e.g., no more than 1 year before the date the score is being determined).

Another context factor may be supply and demand information for identical and/or substantially similar products as the item. For example, in some embodiments, the lower the supply for an item and the higher the demand for an item, the more positively influenced the score for the item will be, thereby increasing the likelihood that the item will be recommended for sale.

Yet another context factor may be a conversion rate for identical and/or substantially similar products as the item. For example, in some embodiments, the higher the percentage of purchases from viewings and/or impressions of items identical or substantially similar to the item being scored, the more positively influenced the score for the item will be, thereby increasing the likelihood that the item will be recommended for sale.

Yet another context factor may be event information related to the item. For example, in some embodiments, if there is a current or upcoming promotional/marketing event for a new version of the item being scored (e.g., a new model of a smartphone has just been launched within the last week), then the score for the item may be positively influenced, thereby increasing the likelihood that the item will be recommended for sale.

Yet another context factor may be if the item being scored is a time-based item that has a particular life cycle. For example, baby supplies (e.g., clothes, cribs, etc.) are often outgrown at a faster rate than many other items. As a result, the owners of baby supplies might be more interested in selling those items than other items. Therefore, an item having been determined to have this characteristic (e.g., by comparing the product identification or the category identification of the item with a predetermined list of product identifications or category identifications associated with this characteristic) may have its score positively influenced, thereby increasing the likelihood that the item will be recommended for sale.

It is contemplated that other context factors are also within the scope of the present disclosure and may be employed to influence the score of an item. In some embodiments, any of the context factors (e.g., a promotional/marketing event) may be used to override a decision to filter out an item. For example, an item that otherwise would have been filtered out from consideration for recommendation (e.g., because its ASP is too low) may be brought back into consideration as a result of a promotional/marketing event, or some other context factor, associated with the item.

Recommendation module 460 may be configured to determine which items from the inventory of items to recommend for sale based on the corresponding scores of the items. In some embodiments, the recommendation module 460 may rank the items in the inventory of items based on their corresponding scores. The recommendation module 460 may then select either a top portion or a bottom portion of the ranked items as the item(s) to recommend for sale, depending on whether the scores are ranked in ascending order or descending order from top-to-bottom. The selected portion should represent the scores most positively influenced by the sale price information, purchase date information, and any appropriate context factors in terms of the likelihood of their corresponding items being recommended for sale.

In some embodiments, a scoring method may be used that scores items in a direct relationship with how positively the corresponding factors (e.g., sale price information, purchase date information, context factors) affect their likelihood of being recommended for sale. For example, in some embodiments, the portion of a score attributable to the sale price information will be higher for an item having a high average sale price than for an item having a low average sale price. In these embodiments, the recommendation module 460 may select a top portion of the ranked items as the item(s) to recommend for sale.

In some embodiments, a scoring method may be used that scores items in an inverse relationship with how positively the corresponding factors (e.g., sale price information, purchase date information, context factors) affect their likelihood of being recommended for sale. For example, in some embodiments, the portion of a score attributable to the sale price information will be lower for an item having a high average sale price than for an item having a low average sale price. In these embodiments, the recommendation module 460 may select a bottom portion of the ranked items as the item(s) to recommend for sale.

In some embodiments, the recommendation module 460 may base the selection of one or more items from the user's inventory to be recommended for sale simply on whether the score of an item meets a predetermined threshold. In this respect, the recommendation module 460 may determine whether an item in the user's inventory of items should be recommended for sale regardless of the scores of any of the other items in the user's inventory of items and without ranking the items. Each item in the user's inventory of items may be evaluated for the recommendation determination without comparison to the other items in the user's inventory of items.

In some embodiments, the recommendation module 460 may be further configured to provide to the user a recommendation to sell the determined item(s). In some embodiments, the recommendation may comprise identifying information (e.g., name/title, brand, model number, description, image) of the determined item(s) and the sale price information corresponding to the determined item(s). In some embodiments, the recommendation may be sent to one or more e-mail addresses corresponding to the user. In some embodiments, the recommendation may be displayed to the user on a device of the user while the user is visiting a particular website using the device or in response to the user performing a predetermined action on a particular website using the device. Other forms of providing the recommendation to the user are also within the scope of the present disclosure.

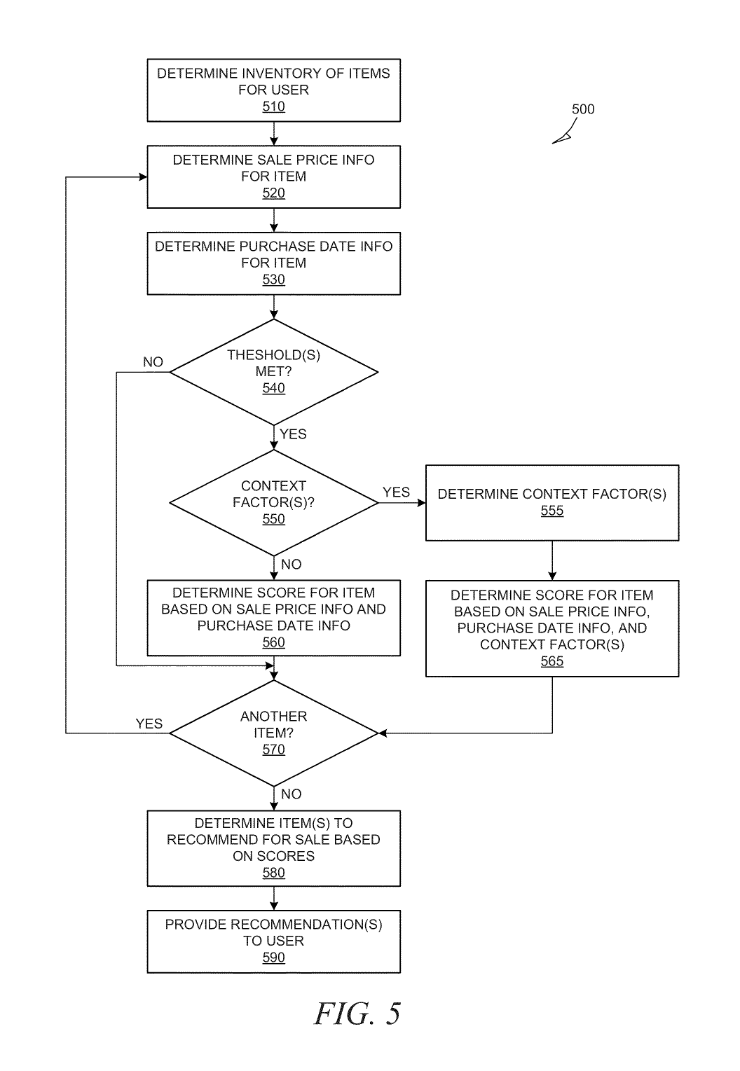

FIG. 5 is a flowchart illustrating a method 500 of generating a recommendation of items to sell, in accordance with some embodiments. The operations of method 500 may be performed by a system or modules of a system (e.g., recommendation system 212 or any of its modules).

At operation 510, an inventory of items may be determined for a user. In some embodiments, the inventory of items may be determined using any of the techniques described herein, such as those previously discussed with respect to the inventory module 410. Other techniques of determining an inventory of items for a user may be employed as well.

At operation 520, sale price information may be determined for an item in the user's inventory of items. In some embodiments, the sale price information may be determined using any of the techniques described herein, such as those previously discussed with respect to the sale price module 420. Other techniques of determining sale price information for an item may be employed as well.

At operation 530, purchase date information may be determined for the item. In some embodiments, the purchase date information may be determined using any of the techniques described herein, such as those previously discussed with respect to the purchase date module 430. Other techniques of determining purchase date information for the item may be employed as well.

At operation 540, it may be determined whether or not the determined sale price information and/or the determined purchase date information meet a predetermined threshold. For example, as previously discussed, a minimum average sale price for items may be set as a threshold. As another example, as previously discussed, a minimum amount of time since items have been purchased by the user may be set as a threshold. Other types of thresholds are also within the scope of the present disclosure and may be employed.

If any of the one or more thresholds at operation 540 are not met, then the method 500 may proceed to operation 570, where it may be determined whether or not there is another item in the user's inventory of items that should be processed for determining whether they should be recommended for sale. The result of this determination will be discussed later below.

If any of the one or more thresholds at operation 540 are met, then the method 500 may proceed to operation 550, where it may be determined whether or not there are any available or appropriate context factors.

If it is determined that there are not any available or appropriate context factors, then the method 500 may proceed to operation 560, where a score for the item may be determined based on the determined sale price information for the item and the determined purchase date information for the item. In some embodiments, the score for the item may be determined using any of the techniques described herein, such as those previously discussed with respect to the item score module 450. Other techniques of determining the score for an item may be employed as well.

If it is determined that there are available or appropriate context factors, then the method 500 may proceed to operation 555, where any relevant context factors are determined. In some embodiments, the relevant context factors may be determined using any of the techniques described herein, such as those previously discussed with respect to the context factor module 440. Other techniques of determining the relevant context factors may be employed as well.

The method 500 may then proceed to operation 565, where a score for the item may be determined based on the determined sale price information for the item, the determined purchase date information for the item, and the determined context factor(s). In some embodiments, the score for the item may be determined using any of the techniques described herein, such as those previously discussed with respect to the item score module 450. Other techniques of determining the score for an item may be employed as well.

After either scoring operations 560 or 565, the method 500 may proceed to operation 570, where, as previously mentioned, it may be determined whether or not there is another item in the user's inventory of items that should be processed for determining whether they should be recommended for sale. If it is determined that there is another item in the user's inventory of items that should be processed, then the method 500 may return to operation 520, where sale price information may be determined for that other item.

If, at operation 570, it is determined that there is not another item in the user's inventory of items that should be processed, then the method 500 may proceed to operation 580, where one or more items from the user's inventory of items may be selected to be recommended for sale. This selection may be based on the corresponding scores of the item(s). In some embodiments, the determination of one or more items to recommend for sale may be performed using any of the techniques described herein, such as those previously discussed with respect to the recommendation module 460. Other techniques of determining one or more items to recommend for sale may be employed as well.

At operation 590, one or more recommendations to sell the determined item(s) may be provided to the user. In some embodiments, the recommendation(s) to sell the determined items may be performed using any of the techniques described herein, such as those previously discussed with respect to the recommendation module 460. Other techniques of providing the recommendation(s) may be employed as well.

It is contemplated that the operations of method 500 may incorporate any of the other features disclosed herein.

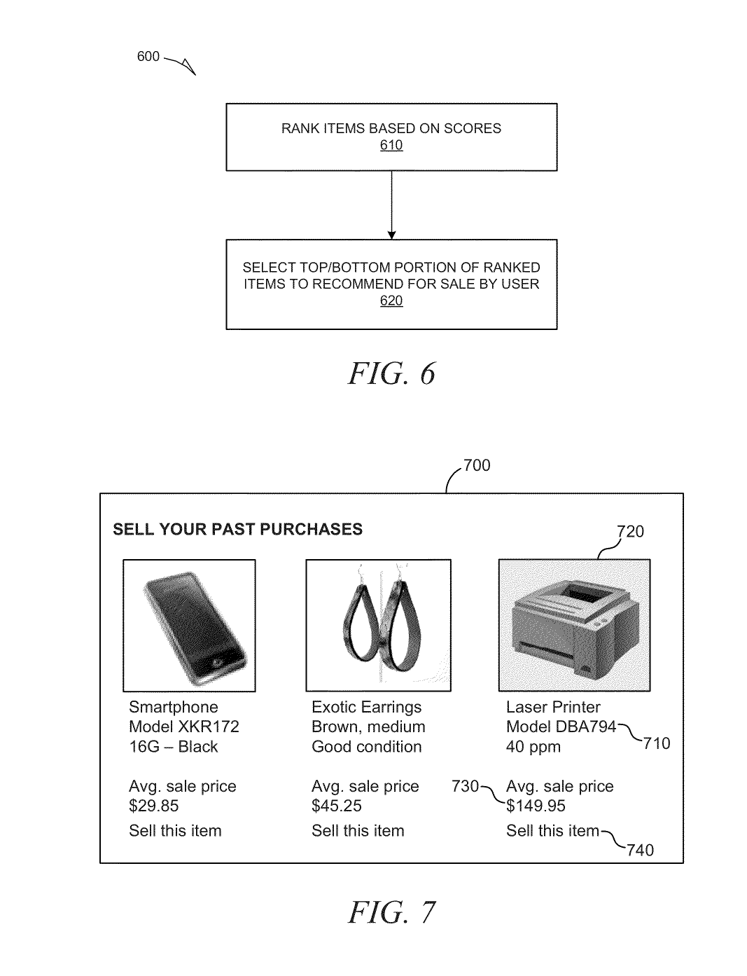

FIG. 6 is a flowchart illustrating a method 600 of selecting items to recommend for sale, in accordance with some embodiments. In some embodiments, the operations of method 600 may be employed at operation 560 in FIG. 5. The operations of method 600 may be performed by a system or modules of a system (e.g., recommendation system 212 or any of its modules).

At operation 610, items in the user's inventory of items may be ranked based on their corresponding scores. In some embodiments, this ranking may be performed using any of the techniques described herein, such as those previously discussed with respect to the recommendation module 460. Other techniques of ranking the items may be employed as well.

At operation 620, either a top or bottom portion of the ranked items may be selected to be recommended for sale by the user. In some embodiments, this selection may be performed using any of the techniques described herein, such as those previously discussed with respect to the recommendation module 460. Other techniques of selecting the items to recommend for sale may be employed as well.

It is contemplated that the operations of method 600 may incorporate any of the other features disclosed herein.

FIG. 7 illustrates a recommendation 700 to sell items, in accordance with some embodiments. The recommendation 700 may comprise identifying information of the items being recommended for sale. In some embodiments, the recommendation 700 may comprise text-based identifying information 710 (e.g., name/title, brand, model number, description) of the items being recommended for sale. In some embodiments, the recommendation 700 may comprise images 720 of the items being recommended for sale. In some embodiments, the recommendation 700 may comprise the corresponding sale price information 730 of the item, such as the corresponding average sale price. In some embodiments, the recommendation 700 may comprise a selectable link 740 for each item being recommended for sale. The selection of this link 740 by the user may initiate the process of the user offering the corresponding item for sale, such as by initiating an online procedure employed by an e-commerce website to list the item for sale on the e-commerce website or some other e-commerce website.

In some embodiments, the recommendation 700 may be included in an e-mail to one or more e-mail addresses corresponding to the user. In some embodiments, the recommendation 700 may be displayed to the user on a device of the user while the user is visiting a particular website using the device or in response to the user performing a predetermined action on a particular website using the device. Other forms of providing the recommendation 700 to the user are also within the scope of the present disclosure.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

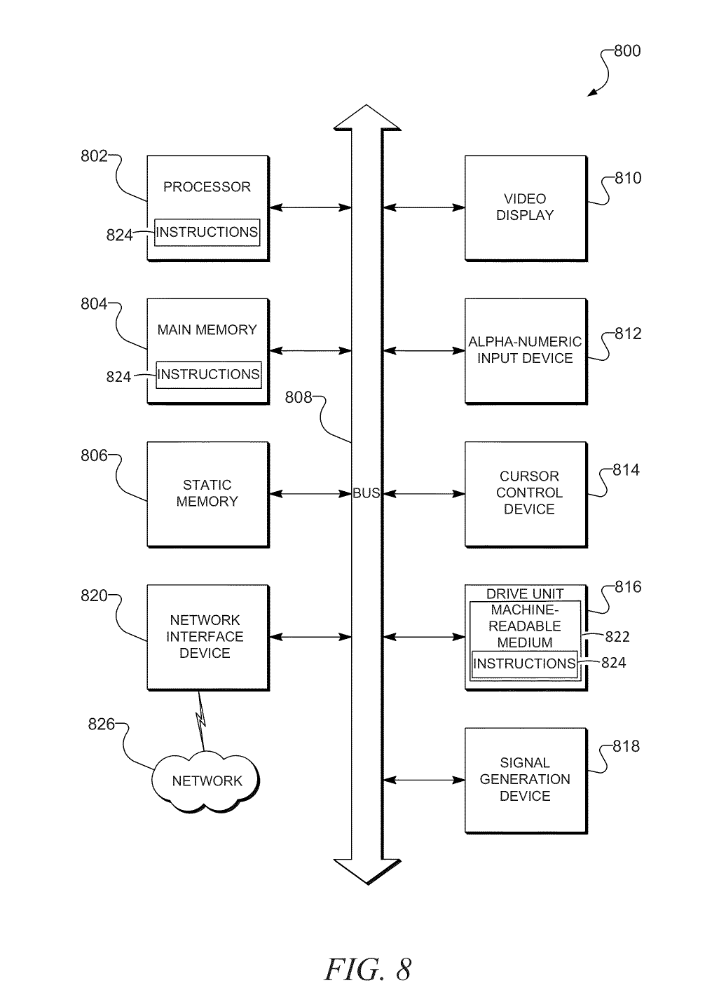

FIG. 8 is a block diagram of a machine in the example form of a computer system 800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a machine having a memory and at least one processor;
an inventory module configured to determine an inventory of items of a user, the inventory of items comprising items the user has purchased;
a sale price module configured to, for each item in the inventory of items, determine corresponding sale price information;
a purchase date module configured to, for each item in the inventory of items, determine corresponding purchase date information reflecting when the user purchased the corresponding item;
an item score module, executable by the at least one processor, configured to, for each item in the inventory of items, determine a score based on the corresponding sale price information and the corresponding purchase date information; and
a recommendation module configured to determine at least one item from the inventory of items to recommend for sale by the user based on the corresponding score of the at least one item.

2. The system of claim 1, wherein the sale price information comprises an average selling price for a plurality of items each having the same product identification as the corresponding item.

3. The system of claim 2, wherein, for each item in the inventory of items, the item score module is configured to determine the score conditioned upon the corresponding average selling price satisfying a minimum threshold.

4. The system of claim 1, wherein, for each item in the inventory of items, the item score module is configured to determine the score conditioned upon the corresponding purchase date information reflecting that a minimum threshold amount of time has passed since the corresponding item was purchased by the user.

5. The system of claim 1, wherein the item score module is configured to weight the corresponding scores of the items based on measurements of the user's buying activity and selling activity in item categories associated with the items.

6. The system of claim 1, wherein the recommendation module is further configured to:
rank the items in the inventory of items based on their corresponding scores; and
select either a top portion or a bottom portion of the ranked items as the at least one item to recommend for sale.

7. The system of claim 1, wherein the recommendation module is further configured to provide, to the user, a recommendation to sell the determined at least one item.

8. The system of claim 17, wherein the recommendation comprises the sale price information corresponding to the determined at least one item.

9. The system of claim 1, wherein the inventory module is configured to access the user's buying and selling history on at least one e-commerce website in determining the inventory of items.

10. A computer-implemented method comprising:
determining an inventory of items of a user, the inventory of items comprising items the user has purchased;
for each item in the inventory of items, determining corresponding sale price information;
for each item in the inventory of items, determining corresponding purchase date information reflecting when the user purchased the corresponding item;
for each item in the inventory of items, determining a score based on the corresponding sale price information and the corresponding purchase date information; and
determining at least one item from the inventory of items to recommend for sale by the user based on the corresponding score of the at least one item.

11. The method of claim 10, wherein the sale price information comprises an average selling price for a plurality of items each having the same product identification as the corresponding item.

12. The method of claim 11, wherein, for each item in the inventory of items, the step of determining a score is conditioned upon the corresponding average selling price satisfying a minimum threshold.

13. The method of claim 10, wherein, for each item in the inventory of items, the step of determining a score is conditioned upon the corresponding purchase date information reflecting that a minimum threshold amount of time has passed since the corresponding item was purchased by the user.

14. The method of claim 10, further comprising weighting the corresponding scores of the items based on measurements of the user's buying activity and selling activity in item categories associated with the items.

15. The method of claim 10, wherein determining at least one item from the inventory of items to recommend for sale comprises:
ranking the items in the inventory of items based on their corresponding scores; and
selecting either a top portion or a bottom portion of the ranked items as the at least one item to recommend for sale.

16. The method of claim 10, further comprising providing, to the user, a recommendation to sell the determined at least one item.

17. The method of claim 16, wherein the recommendation comprises the sale price information corresponding to the determined at least one item.

18. The method of claim 10, wherein determining the inventory of items comprises accessing the user's buying and selling history on at least one e-commerce website.

19. A non-transitory machine-readable storage device storing a set of instructions that, when executed by at least one processor, causes the at least one processor to perform a set of operations comprising:
determining an inventory of items of a user, the inventory of items comprising items the user has purchased;
for each item in the inventory of items, determining corresponding sale price information;
for each item in the inventory of items, determining corresponding purchase date information reflecting when the user purchased the corresponding item;
for each item in the inventory of items, determining a score based on the corresponding sale price information and the corresponding purchase date information; and
determining at least one item from the inventory of items to recommend for sale by the user based on the corresponding score of the at least one item.

20. The machine-readable storage device of claim 19, wherein the sale price information comprises an average selling price for a plurality of items each having the same product identification as the corresponding item.
